(19) United States
(12) Patent Application Publication
(10) Pub. No.: US 2007/0271944 A1
(43) Pub. Date: Nov. 29, 2007

(54) REDUCED CALORIE FROZEN BEVERAGE

(75) Inventors: Sandra C. Ryan, Kennesaw, GA (US); Richard C. Staten, Woodstock, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Coca-Cola Company, Atlanta, GA (US)

(21) Appl. No.: 11/565,719

(22) Filed: Dec. 1, 2006

Related U.S. Application Data
(60) Provisional application No. 60/741,471, filed on Dec. 2, 2005.

(51) Int. Cl. A23G 9/00; A23L 2/00

(52) U.S. Cl. 62/342; 426/590

(57) ABSTRACT

Disclosed herein is a reduced calorie frozen beverage and a syrup used for producing the same from a mechanical dispenser. The reduced calorie beverage of the invention provides enhanced taste and can be produced in low sodium and very low sodium versions.

The present disclosure relates to the production of reduced calorie frozen beverages. More particularly, the present disclosure relates to the production of reduced calorie frozen beverages made with a sweetening system that provides enhanced taste. The present invention also relates to reduced calorie frozen beverages that are low or very low in sodium.

Full calorie frozen carbonated beverages (FCBs) and frozen non-carbonated beverages are known in the art. These frozen beverages are commercially produced via dynamic devices that freeze a mixture of ingredients including syrup, water and optionally, carbon dioxide or other gases in a mixing chamber. The mixture freezes on the inner surface of the mixing chamber, which is surrounded by an evaporator through which a refrigerant is passed. A mixer, for example, a rotating shaft which has a plurality of outwardly projecting or helical blades/auger that scrape the mixture off the inside walls of the mixing chamber is disposed inside the mixing chamber. Once the beverage is in the desired frozen state, the product is dispensed from the mixing chamber through a product dispensing valve.

The temperature and viscosity of the ingredients within the mixing chamber are maintained by a control system that controls the refrigeration system. Product quality is controlled through the balance of ingredients and product agitation as well as pressures and temperatures within the mixing chamber. The chemical properties of these ingredients that make up the frozen beverage play an important part in the normal functioning of these mechanical frozen beverage dispensing devices and the quality of the frozen beverage products.

Known FCB products have generally been limited to full calorie FCBs. Full calorie products rely upon common sugars, such as sucrose or high fructose corn syrup (HFCS) both as sweeteners and as freezing aids. Under normal operating conditions of a frozen beverage machine, the addition of caloric sweeteners depresses the freezing point of the product mixture making them dispensable in a slush-like state. As used herein, “slush” and “slush-like” are synonymous. These terms refer to the physical properties of the frozen beverage, whereby the frozen beverage is not frozen into a solid state, but the viscosity of the beverage is higher than its liquid state at room temperature.

By contrast, producing a frozen beverage from a diet cola containing only non-caloric sweeteners, lacks a freezing point modifier. Without a modified freezing point, diet syrup would freeze into a block of ice in a frozen beverage machine, rather than attaining the slush-like property found in full-calorie beverages. Currently marketed reduced calorie frozen beverages use either sugar polyols (associated with laxative effects) or salts to modify the freezing point. Thus, a need continues to exist for reduced calorie frozen beverages that are dispensable and that can satisfy the consumers desire for lower calories without sacrificing the taste of full calorie frozen beverages.

Consumers, while desiring a refreshing frozen beverage, are often concerned with the amounts of sugar and salt that they are consuming. These concerns are multiplied when one considers that these frozen beverages are often sold in large sizes, for example 24 oz or 36 oz, some even reaching 40 oz to 64 oz. The present invention provides a sweetener system which more closely mimics the taste of full calorie beverages which are sweetened using only full-calorie sugars, often high fructose corn syrup, while achieving a reduction in calories, thus resulting in a reduced calorie frozen beverage with enhanced flavour. Further, the sweetener system of the present disclosure can be used without added sodium which has conventionally been used for a variety of purposes including to modify the freezing point and/or the taste of frozen beverages. Thus the frozen beverages of the present disclosure can be offered in both low sodium or very low sodium versions.

As used herein, “low” sodium and “very low sodium” are defined by 21 CFR 100.61.

Thus, the present invention provides beverage products which address the consumer's health concerns while still maintaining flavours and sweetness that have heretofore only been associated with full calorie frozen beverages. Further, it does this while not interfering with the dispensability of the frozen beverage through existing dispenser equipment.

The frozen beverage according to the present invention may be carbonated or uncarbonated/ungassed. The frozen beverage is produced from a reduced calorie beverage syrup in combination with water, optionally also including carbon dioxide. As used herein “reduced-calorie” means a beverage have a calorie reduction of at least 25% when compared with a its full-calorie version. As used herein “full-calorie version” refers to a beverage or syrup formulation in which the sweetening system has been replaced with an appropriate amount of sucrose. In one embodiment, the reduced-calorie beverage of the present disclosure has at least a 30% reduction in calories. In another embodiment, the frozen beverage of the disclosure has a calorie reduction of at least 35%. In yet another embodiment of the invention, the frozen beverage has a calorie reduction of at least 40%.

The reduced calorie frozen beverage syrup according to the present invention comprises a flavouring system and a sweetener system.

The flavouring system may include any art recognized flavouring system for producing a consumable beverage. More particularly, the flavouring system comprising natural and/or artificial flavours. In one embodiment, the flavouring system includes all natural flavours. In another embodiment, the flavouring system includes a combination of natural and artificial flavours. In yet another embodiment, the flavouring system includes only artificial flavours.

According to one embodiment, the flavouring system is that of a cola product and comprises caffeine, natural flavours and caramel color. According to another embodiment, the flavouring system comprises citric acid.

The flavouring system can further comprise additional flavour components which will be readily apparent to the skilled artisan. Additional flavour components can include but are not limited to caffeine, phosphoric acid, caramel color, propylene glycol, citric acid, fruit flavours including lemon, orange, lime, cherry, strawberry, raspberry, grape, and grapefruit, cola, root beer, coffee, tea, botanical flavors including flavors derived from nuts, bark, roots and leaves and mixtures thereof.

The sweetener system comprises at least one nutritive and at least two non-nutritive sweeteners. Nutritive sweeteners for use in the present invention can include any recognized nutritive sweetener including, but not limited to, sugars, including high fructose corn syrup, sucrose, glucose, fructose, lactose, cane sugar, beet sugar, maltose, dextrose, maltodextrin, crystalline fructose and fruit juice concentrates. The amount of nutritive sweetener can be minimized to the limit of dispensability or can be increased, but the skilled artisan would recognize that any increase would cause a concurrent increase in the calorie content of the frozen beverage. According to one embodiment, the nutritive sweetener is present in the beverage syrup in an amount ranging from 15 to 45%. When water and optionally an expansion gas are added and the final reduced calorie frozen beverage is produced, the amount of nutritive sweetener in the final beverage can range, for example, from between 5% and 20%. In another embodiment, the nutritive sweetener in the syrup ranges from 15% to 35%. In yet another embodiment, the nutritive sweetener in the syrup ranges from 25% to 45%.

The at least two non-nutritive sweeteners are chosen from aspartame, sucralose and acesulfame (K). According to one embodiment, the non-nutritive sweetener is present in the beverage syrup in an amount ranging 0.02 to 3%. In another embodiment, the non-nutritive sweetener ranges from 0.04 to 1.0%. In yet another embodiment, the non-nutritive sweetener ranges from 0.03 to 0.08%.

The sweetening system may include additional sweetening additives which include but are not limited to saccharin and neotame.

According to one embodiment, the frozen beverage syrup of the present disclosure comprises up to 5% aspartame and up to 5% Acesulfame-K. According to yet another embodiment, the sweetener system of the present invention comprises Aspartame and Acesulfame-K, wherein there is less Acesulfame-K present than Aspartame.

Other optional ingredients which may be present in the frozen beverage syrup according to the present invention include, preservatives, colorants, foaming agents, vitamins (including A, B3, B6, B12, C and E), minerals (including magnesium, potassium, calcium), fruit juice, and tea solids. Preservatives can include any art recognized preservatives, including but not limited to, potassium benzoate, sodium benzoate, potassium sorbate, and EDTA. Colorants can include any art recognized colorants, including by not limited to artificial colors, natural colors (including caramel color), fruit and vegetable juice extracts. Saponins or foaming agents can include any art recognized foaming agents, including, but not limited to Quillaia, Yucca extract and propylene glycol alginate.

According to one embodiment, the reduced calorie frozen beverage of the disclosure is a frozen cola beverage. According to this embodiment, the product may include the following components and amounts.

| Ingredient | Syrup | Beverage |
|---|---|---|
| Water | 45-75% | 60-85% |
| Sugar | 20-40% | 5-15% |
| Aspartame | less than 5% | less than 5% |
| Acesulfame-K | less than 5% | less than 5% |
| Caffeine | less than 5% | less than 5% |
| Phosphoric acid | less than 5% | less than 5% |
| Natural flavours | less than 5% | less than 5% |
| Caramel color | less than 5% | less than 5% |
| Yucca extract | less than 5% | less than 5% |
| Quillaia | less than 5% | less than 5% |
| Propylene glycol | less than 5% | less than 5% |

According to another embodiment, the reduced calorie frozen beverage of the disclosure is a frozen non-cola beverage. According to this embodiment, the product may include the following components and amounts:

| Ingredient | Syrup | Beverage |
|---|---|---|
| Water | 45-75% | 60-85% |
| Sugar | 20-40% | 5-15% |
| Citric acid | less than 5% | less than 5% |
| Potassium benzoate | less than 5% | less than 5% |
| Aspartame | less than 5% | less than 5% |
| Acesulfame-K | less than 5% | less than 5% |

The non-cola beverage may be further combined with a secondary flavouring system after dispensing of the product from the mixing chamber. Incorporation of the secondary flavouring system may occur after the beverage is dispensed into a cup. Appropriate flavouring systems will be readily apparent to the skilled artisan and might include for example, cherry, blue raspberry, lemon/lime, grape, strawberry, raspberry, grapefruit, cola, rootbeer, orange, tea, vanilla, coconut, passion fruit, mango, and combinations thereof.

Frozen beverages according to the present disclosure exhibit enhanced taste. As used herein, “enhanced taste” refers to a frozen beverage whose taste is considered to more closely resemble the taste of a full-calorie version frozen beverage. For purposes of the present invention, “taste” is to be measured by a panel of 100 people who are asked to taste and evaluate the products. The tasters are selected based upon demographic criteria, for example, age and type of beverages they prefer. The correct measuring demographic for “enhanced taste” associated with the present invention are those people who prefer full-calorie or mid-calorie drinks.

According to one embodiment of the invention, the frozen beverage of the present invention does not suffer from the laxative effect that can often be associated with sugar substitutes. For example, ingredients such as isomalt, malitol and lactitol are not well absorbed by the small intestine and thus, they enter the large intestine where they are fermented by anaerobic bacteria to produce short chain fatty acids and gases. Short chain fatty acids have a high water binding activity providing possible effects such as soft stools and diarrhea.

Other than in the examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by the embodiments disclosed herein. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the disclosed embodiments are approximations, unless otherwise indicated the numerical values set forth in the specific examples are reported as precisely as possible. Any numerical value, however, inherently contain certain errors necessarily resulting from the standard deviation found in their respective testing measurements.

The embodiments disclosed herein are illustrated in greater detail by the examples described below.

### EXAMPLES

### Example 1

A light cola frozen beverage syrup was produced by combining

53.03% Water

45.50% High Fructose Corn Syrup

0.04% Aspartame

0.02% Acesulfame-K

0.05% Caffeine

0.30% Phosphoric Acid

0.08% Natural Flavours

0.75% Carmel Color

0.10% Yucca Extract

0.10% Quillaia

0.01% Propylene Glycol

The frozen beverage syrup was placed into the mixing chamber of a mechanical frozen beverage dispenser with 4.4:1 water and carbon dioxide. After cooling, a slush-like frozen carbonated beverage was dispensed.

### Example 2

A neutral slush base syrup was produced by combining:

67.07% water

32.30% high fructose corn syrup

0.44% citric acid

0.13% potassium benzoate

0.04% Aspartame

0.02% Acesulfame-K

The neutral slush base syrup was placed into the mixing chamber of a mechanical frozen beverage dispenser with 4.5:1 water. After cooling, a slush-like frozen uncarbonated beverage was dispensed. To the neutral base was added an additional flavour component.

We claim:

1. A system for dispensing reduced calorie frozen beverages comprising:
a dynamic beverage dispenser comprising a mixing chamber for containing a frozen beverage syrup, a refrigeration system for rendering the frozen beverage syrup in a slush state, a mixer for mixing said slush beverage, and a product dispenser for dispensing said reduced calorie frozen beverage; and
a frozen beverage syrup comprising a flavouring system and a sweetener system, wherein the sweetener system comprises at least one nutritive sweetener and at least two non-nutritive sweeteners chosen from aspartame, sucralose and acesulfame (K) contained within the housing.

2. The system of claim 1, wherein the beverage syrup has low sodium.

3. The system of claim 2, wherein the beverage syrup has very low sodium.

4. The system of claim 1, wherein the flavouring system comprises at least one of caffeine, phosphoric acid, caramel color, propylene glycol, citric acid, fruit flavors, cola, root beer, coffee, tea, and botanical flavors.

5. The system of claim 1, wherein the at least one nutritive sweetener is chosen from high fructose corn syrup, sucrose, glucose, fructose, lactose, cane sugar, beet sugar, maltose, dextrose, maltodextrin, crystalline fructose and fruit juice concentrates.

6. The system of claim 1, wherein the at least one nutritive sweetener is present in the beverage syrup in an amount ranging from 15 to 45%.

7. The system of claim 6, wherein the nutritive sweetener is present in the beverage syrup in an amount ranging from 25 to 35%.

8. The system of claim 1, wherein the nutritive sweetener is present at the limit of dispensability.

9. The system of claim 1, wherein the non-nutritive sweetener is present in the beverage syrup in an amount ranging from 0.02 to 3%.

10. The system of claim 9, wherein the non-nutritive sweetener is present in the beverage syrup in an amount ranging from 0.04 to 1%.

11. The system of claim 1, wherein the at least two non-nutritive sweeteners are aspartame and acesulfame (K).

12. The system of claim 11, wherein the aspartame is present in an amount up to 5%.

13. The system of claim 11, wherein the acesulfame (K) is present in an amount up to 5%.

14. The system of claim 11, wherein the amount of acesulfame (K) present is less than the amount of aspartame present.

15. The system of claim 1, wherein the beverage syrup further comprises at least one additional sweetening additive chosen from saccharin and neotame.

16. The system of claim 1, wherein the beverage syrup further comprises one or more preservatives, colorants, foaming agents, vitamins, minerals, fruit juices and tea solids.

17. A frozen carbonated or non-carbonated beverage syrup comprising:
a flavouring system and a sweetener system, wherein the sweetener system comprises at least one nutritive sweetener and at least two non-nutritive sweeteners chosen from aspartame, sucralose and acesulfame (K).

18. The frozen carbonated or non-carbonated beverage syrup of claim 17, wherein the beverage has low sodium.

19. The frozen carbonated or non-carbonated beverage syrup of claim 17, wherein the nutritive sweetener is present at the limit of dispensability.

20. The frozen carbonated or non-carbonated beverage syrup of claim 17, wherein the non-nutritive sweetener is present in an amount ranging from 0.02 to 3%.

21. The frozen carbonated or non-carbonated beverage syrup of claim 17, wherein the at least two non-nutritive sweeteners are aspartame and acesulfame (K).

22. The frozen carbonated or non-carbonated beverage syrup of claim 22, wherein the amount of acesulfame (K) present is less than the amount of aspartame present.

23. A frozen carbonated or non-carbonated beverage comprising:
a flavouring system and a sweetener system, wherein the sweetener system comprises at least one nutritive sweetener and at least two non-nutritive sweeteners chosen from aspartame, sucralose and acesulfame (K); and
water.

24. The frozen carbonated or non-carbonated beverage of claim 23, wherein the beverage has low sodium.

25. The frozen carbonated or non-carbonated beverage of claim 23, wherein the beverage has very low sodium.

26. The frozen carbonated or non-carbonated beverage of claim 23, wherein the nutritive sweetener is present at the limit of dispensability.

27. The frozen carbonated or non-carbonated beverage of claim 23, wherein the non-nutritive sweetener is present in the beverage syrup in an amount ranging from 0.02 to 3%.

28. The frozen carbonated or non-carbonated beverage of claim 23, wherein the at least two non-nutritive sweeteners are aspartame and acesulfame (K).

29. The frozen carbonated or non-carbonated beverage of claim 28, wherein the amount of acesulfame (K) present is less than the amount of aspartame present.
